(19) United States
(12) Patent Application Publication
(10) Pub. No.: US 2013/0110315 A1
(43) Pub. Date: May 2, 2013

(54) DRIVING ASSISTANCE APPARATUS

(71) Applicant: Yuki OGAWA, Toyota-shi (JP)

(72) Inventor: Yuki OGAWA, Toyota-shi (JP)

(21) Appl. No.: 13/666,242

(22) Filed: Nov. 1, 2012

(30) Foreign Application Priority Data
Nov. 1, 2011 (JP) 2011-240589

(51) Int. Cl. G06F 17/00

(52) U.S. Cl. 701/1

(57) ABSTRACT

A driving assistance apparatus includes a target vehicle speed determination unit that obtains, on the basis of a current vehicle speed, the relative position information between a vehicle and a traffic light location, and the light information relating to a change in a display condition of a traffic light, an arrival timing at the traffic light location following travel at the current vehicle speed, and that determines a vehicle speed region in which the vehicle is permitted to pass through the traffic light location as a target vehicle speed region when the display condition at the arrival timing corresponds to a passage permitting display condition, or when the display condition at the arrival timing corresponds to a passage non-permitting display condition and a time remaining until the display condition changes from the passage non-permitting display condition to the passage permitting display condition is within a first threshold time.

### INCORPORATION BY REFERENCE

The disclosure of Japanese Patent Application No. 2011-240589 filed on Nov. 1, 2011 including the specification, drawings and abstract is incorporated herein by reference in its entirety.

### BACKGROUND OF THE INVENTION

1. Field of the Invention

The invention relates to a driving assistance apparatus.

2. Description of Related Art

Recently, vehicles such as automobiles may be installed with a driving assistance apparatus that assists driving by a driver. For example, Japanese Patent Application Publication No. 2004-220332 (JP-2004-220332 A), Japanese Patent Application Publication No. 2010-247703 (JP-2010-247703 A), and Japanese Patent Application Publication No. 2010-33203 (JP-2010-33203 A) describe driving assistance apparatuses that perform travel assistance on the basis of a travel condition of a vehicle and a condition of a traffic light so that the vehicle can pass through an intersection appropriately. JP-2004-220332 A, for example, describes an in-vehicle device having a travel speed calculation unit that calculates a travel speed on the basis of an elapsed green light time following a change from a red light to a green light, a duration of the green light, a travel position, and traffic amount information. Further, JP-2010-247703 A describes a vehicle speed control apparatus that controls a vehicle speed in accordance with a timing at which a display of a traffic signal ahead of a vehicle changes. Furthermore, JP-2010-33203 A describes a control method for nonstop travel at an intersection in which a recommended travel speed vopt required to pass through a green light without stopping at an intersection is calculated at fixed time intervals after passing a specific location, and the recommended travel speed vopt is compared with a host vehicle travel speed v at that time. When the host vehicle travel speed v is higher than the recommended travel speed vopt, travel is performed at the recommended travel speed vopt until the recommended travel speed is calculated again, and when the host vehicle travel speed v is equal to or lower than the recommended travel speed vopt, travel is performed at the current travel speed v until the recommended travel speed is calculated again.

The apparatuses described in JP-2004-220332 A and JP-2010-247703 A notify a driver of a travel condition enabling the driver to pass through a location of a traffic light without stopping by displaying a recommended travel speed. The apparatus described in JP-2010-33203 A facilitates nonstop passage through a traffic light location by performing control such that travel is performed at the recommended travel speed.

The apparatuses described in JP-2004-220332 A, JP-2010-247703 A, and JP-2010-33203 A calculate a recommended vehicle speed by calculating a traffic light passage timing on the basis of various conditions. In certain cases, however, it may be impossible to pass through the traffic light comfortably by traveling on the basis of the calculation result.

### SUMMARY OF THE INVENTION

The invention provides a driving assistance apparatus that can assist driving by a driver more appropriately.

A first aspect of the invention relates to a driving assistance apparatus that assists driving of a vehicle. The driving assistance apparatus includes: a vehicle speed sensor that detects a vehicle speed of the vehicle; a communication unit that obtains light information relating to a change in a display condition of a traffic light disposed in an advancement direction of the vehicle; a position calculation unit that calculates relative position information between the vehicle and a traffic light location where the traffic light is disposed; and a target vehicle speed determination unit that obtains, on the basis of a current vehicle speed detected by the vehicle speed sensor, the relative position information between the vehicle and the traffic light location, calculated by the position calculation unit, and the light information obtained by the communication unit, an arrival timing at the traffic light location following travel at the current vehicle speed, and that determines a vehicle speed region in which the vehicle is permitted to pass through the traffic light location as a target vehicle speed region when the display condition of the traffic light at the arrival timing corresponds to a passage permitting display condition in which vehicle passage is permitted, or when the display condition of the traffic light at the arrival timing corresponds to a passage non-permitting display condition indicating that the vehicle passage is not permitted and a time remaining from the arrival timing until the display condition of the traffic light changes from the passage non-permitting display condition to the passage permitting display condition is within a first threshold time.

The target vehicle speed determination unit may determine, as the target vehicle speed region, a vehicle speed region required to pass through the traffic light location following a change in the display condition of the traffic light from the passage non-permitting display condition to the passage permitting display condition when the display condition of the traffic light at the arrival timing corresponds to the passage non-permitting display condition and the time remaining from the arrival timing until the display condition of the traffic light changes from the passage non-permitting display condition to the passage permitting display condition is within the first threshold time.

The target vehicle speed determination unit may determine to assist stopping of the vehicle at the traffic light location when the arrival timing is between a point after a second threshold time elapses following a change from the passage permitting display condition to the passage non-permitting display condition and a point preceding, by the first threshold time, a change from the passage non-permitting display condition to the passage permitting display condition.

The target vehicle speed determination unit may lengthen the first threshold time as a distance between the vehicle and the traffic light location, calculated by the position calculation unit, increases and shorten the first threshold time as the distance between the vehicle and the traffic light location, calculated by the position calculation unit, decreases.

The target vehicle speed determination unit may calculate, as the target vehicle speed region, a vehicle speed region required to pass through the traffic light location between a point following the elapse of a fourth threshold time after a change in the display condition of the traffic light from the passage non-permitting display condition to the passage permitting display condition and a point preceding, by a third threshold time, a change in the display condition of the traffic light from the passage permitting display condition to the passage non-permitting display condition.

The target vehicle speed determination unit may calculate, as the target vehicle speed region, a vehicle speed region required to pass through the traffic light location while the display condition of the traffic light corresponds to the passage permitting display condition.

The driving assistance apparatus may further include a target vehicle speed notification unit that notifies of the target vehicle speed region determined by the target vehicle speed determination unit.

A second aspect of the invention relates to a driving assistance apparatus that assists driving of a vehicle. The driving assistance apparatus includes: a vehicle speed sensor that detects a vehicle speed of the vehicle; a communication unit that obtains light information relating to a change in a display condition of a traffic light disposed in an advancement direction of the vehicle; a position calculation unit that calculates relative position information between the vehicle and a traffic light location where the traffic light is disposed; and a target vehicle speed determination unit that obtains, on the basis of a current vehicle speed detected by the vehicle speed sensor, the relative position information between the vehicle and the traffic light location, calculated by the position calculation unit, and the light information obtained by the communication unit, an arrival timing at the traffic light location following travel at the current vehicle speed, and that determines a vehicle speed region in which the vehicle is permitted to pass through the traffic light location as a target vehicle speed region when the display condition of the traffic light at the arrival timing corresponds to a passage permitting display condition indicating that vehicle passage is permitted, or when the display condition of the traffic light at the arrival timing corresponds to a passage non-permitting display condition indicating that the vehicle passage is not permitted and an elapsed time following a change in the display condition of the traffic light from the passage permitting display condition to the passage non-permitting display condition up to the arrival timing is within a second threshold time.

The target vehicle speed determination unit may determine to assist stopping of the vehicle at the traffic light location when the arrival timing is between a point after the second threshold time elapses following a change from the passage permitting display condition to the passage non-permitting display condition and a point preceding, by a first threshold time, a change from the passage non-permitting display condition to the passage permitting display condition.

The target vehicle speed determination unit may lengthen the second threshold time as a distance between the vehicle and the traffic light location, calculated by the position calculation unit, increases and shorten the second threshold time as the distance between the vehicle and the traffic light location, calculated by the position calculation unit, decreases.

The target vehicle speed determination unit may calculate, as the target vehicle speed region, a vehicle speed region required to pass through the traffic light location between a point following the elapse of a fourth threshold time after a change in the display condition of the traffic light from the passage non-permitting display condition to the passage permitting display condition and a point preceding, by a third threshold time, a change in the display condition of the traffic light from the passage permitting display condition to the passage non-permitting display condition.

The target vehicle speed determination unit may calculate, as the target vehicle speed region, a vehicle speed region required to pass through the traffic light location while the display condition of the traffic light corresponds to the passage permitting display condition.

The driving assistance apparatus may further includes a target vehicle speed notification unit that notifies of the target vehicle speed region determined by the target vehicle speed determination unit.

A third aspect of the invention relates to a driving assistance apparatus that assists driving of a vehicle. The driving assistance apparatus includes: a vehicle speed sensor that detects a vehicle speed of the vehicle; a communication unit that obtains light information relating to a change in a display condition of a traffic light disposed in an advancement direction of the vehicle; a position calculation unit that calculates relative position information between the vehicle and a traffic light location where the traffic light is disposed; and a target vehicle speed determination unit that determines whether or not the vehicle is permitted to pass through the traffic light location on the basis of the relative position information between the vehicle and the traffic light location, calculated by the position calculation unit, and the light information obtained by the communication unit, and that, after determining that the vehicle is permitted to pass through the traffic light location, determines, as a target vehicle speed region, a vehicle speed region required to pass through the traffic light location between a point following the elapse of a fourth threshold time after a change in a display condition of the traffic light from a passage non-permitting display condition indicating that vehicle passage is not permitted to a passage permitting display condition indicating that the vehicle passage is permitted and a point preceding, by a third threshold time, a change in the display condition of the traffic light from the passage permitting display condition to the passage non-permitting display condition.

The driving assistance apparatus may further includes a target vehicle speed notification unit that notifies of the target vehicle speed region determined by the target vehicle speed determination unit.

According to the configurations described above, driving by a driver can be assisted more appropriately.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an illustrative view showing an example of a driving assistance system according to an embodiment;

FIG. 2 is a block diagram showing a schematic configuration of a vehicle installed with a driving assistance apparatus according to this embodiment;

FIG. 3 is a schematic diagram showing an example of a vehicle speed display region of a display device;

FIG. 4 is a flowchart showing an example of processing performed by the driving assistance apparatus;

FIG. 5 is a flowchart showing an example of the processing performed by the driving assistance apparatus;

FIG. 6 is an illustrative view illustrating an example of determination processing performed during a passage determination;

FIG. 7 is schematic diagram showing an example of the vehicle speed display region of the display device;

FIG. 8 is schematic diagram showing an example of the vehicle speed display region of the display device;

FIG. 9 is an illustrative view illustrating an example of target vehicle speed region determination processing;

FIG. 10 is schematic diagram showing an example of the vehicle speed display region of the display device;

FIG. 11 is a flowchart showing another example of the processing performed by the driving assistance apparatus; and

FIG. 12 is a schematic diagram showing another example of the vehicle speed display region of the display device.

### DETAILED DESCRIPTION OF EMBODIMENTS

A driving assistance apparatus according to an embodiment of the invention will be described in detail below with reference to the drawings. Note that the invention is not limited to this embodiment. Further, constituent elements of the following embodiment include elements that could be envisaged easily by a person skilled in the art and substantially identical elements.

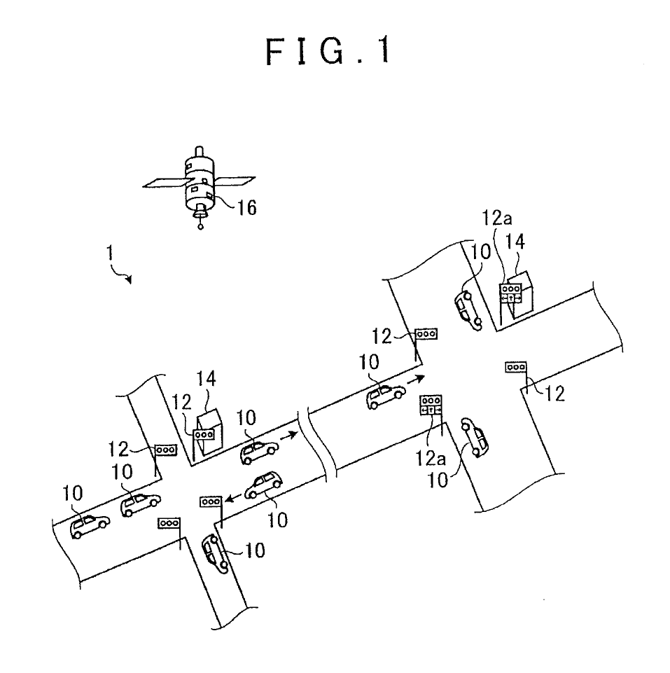

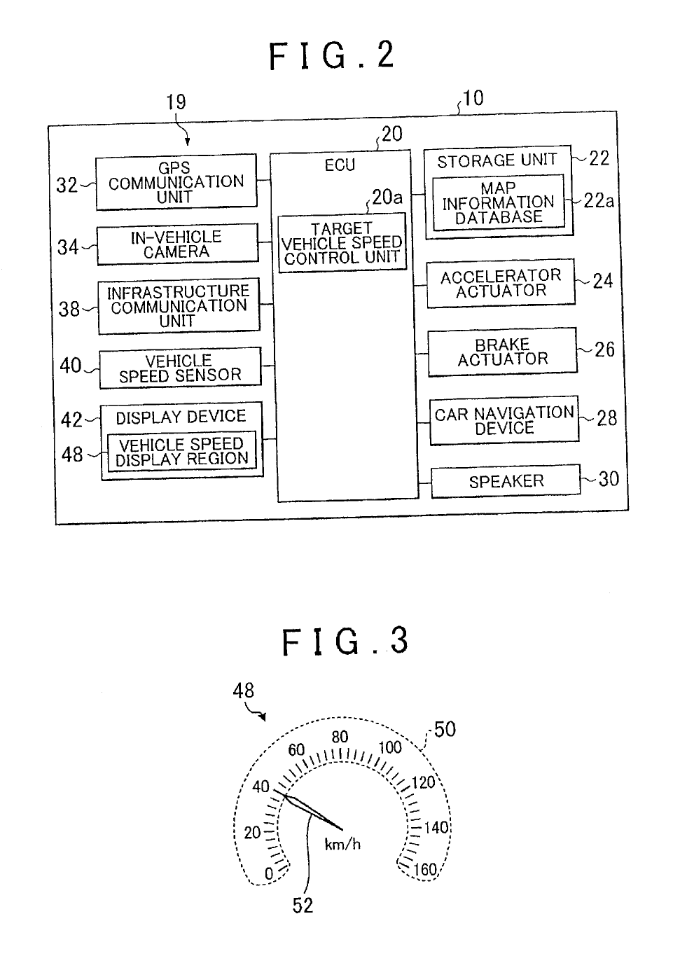

Referring to FIGS. 1 to 8, an embodiment will be described. This embodiment relates to a driving assistance system including a vehicle installed with a driving assistance apparatus. First, using FIGS. 1 to 3, a configuration of the driving assistance system including the vehicle installed with the driving assistance apparatus will be described. FIG. 1 is an illustrative view showing an example of the driving assistance system according to this embodiment. FIG. 2 is a block diagram showing a schematic configuration of the vehicle installed with the driving assistance apparatus according to, this embodiment. FIG. 3 is a schematic diagram showing an example of a vehicle speed display region of a display device.

A driving assistance system 1 shown in FIG. 1 includes a plurality of vehicles 10, a plurality of traffic lights 12, 12a, a plurality of infrastructure information transmission apparatuses 14, and a global positioning system (GPS) satellite 16. The driving assistance system 1 assists driving by a driver of a vehicle 10 installed with a driving assistance apparatus 19 to be described below, from among the plurality of vehicles 10, on the basis of driving assistance information. The driving assistance information is obtained by detecting a relationship with another vehicle 10 and obtained from the infrastructure information transmission apparatuses 14 and the GPS satellite 16.

The vehicles 10 are vehicles that can travel on roads, for example automobiles, trucks, and the like. The vehicles 10 are capable of traveling on roads on which the traffic lights 12, 12a are disposed. A configuration of the vehicle 10 will be described below.

The traffic lights 12, 12a are light apparatuses disposed at intersections. The traffic light 12 includes light portions in three colors, namely green, yellow, and red. The traffic light 12a includes, in addition to the light portions in the three colors, a light portion that displays an arrow (an arrow light portion). The traffic lights 12, 12a are disposed on roads in respective vehicle travel directions. The traffic light 12 indicates whether a vehicle 10 traveling on a corresponding road is permitted to pass in the travel direction of the vehicle 10 or the vehicle 10 is not permitted to pass, i.e. the vehicle 10 must stop, by switching an illuminated light portion from among the light portions in the three colors. In the driving assistance system 1 shown in FIG. 1, the traffic lights 12, 12a are disposed at intersections, but disposal positions of the traffic lights 12, 12a are not limited to intersections, and the traffic lights 12, 12a may be disposed at pedestrian crossings, for example. In FIG. 1, the traffic lights 12, 12a are depicted such that all of the light portions are visible, but the traffic lights 12, 12a are disposed to be visible by vehicles 10 advancing toward the light portions (vehicles intending to pass through the traffic lights 12, 12a).

The infrastructure information transmission apparatuses 14 transmit infrastructure information such as road information relating to the roads on which the vehicles 10 travel and traffic light information relating to the traffic lights 12, 12a ahead of the vehicles 10 in the travel direction. The infrastructure information transmission apparatus 14 according to this embodiment is disposed at each intersection in order to transmit the infrastructure information to vehicles 10 traveling within a fixed range around the intersection through wireless communication. Here, the road information typically includes vehicle speed limit information, intersection stop line position information, and so on relating to the roads on which the vehicles 10 are traveling. The traffic light information typically includes light cycle information such as an illumination cycle of the green light, the yellow light, and the red light of the traffic lights 12, 12a, and light change timings. The infrastructure information transmission apparatus 14 may be provided for each traffic light 12, 12a, or may be provided singly for a plurality of intersections.

The GPS satellite 16 outputs GPS signals required for position detection by a Global Positioning System (GPS). FIG. 1 shows only one GPS satellite 16, but the driving assistance system 1 includes at least three GPS satellites 16. An apparatus for detecting a position using GPS receives GPS signals output from the at least three GPS satellites 16, and detects a position of a host apparatus by comparing the received GPS signals.

Next, using FIG. 2, the vehicle 10 installed with the driving assistance apparatus 19 will be described. In the driving assistance system 1 shown in FIG. 1, all of vehicles 10 are installed with the driving assistance apparatuses 19, but it is sufficient for at least one of the vehicles 10 to be installed with the driving assistance apparatus 19. In other words, in the driving assistance system 1, vehicles not installed with the driving assistance apparatus 19 may travel in front of and behind the vehicle 10 installed with the driving assistance apparatus 19.

The vehicle 10 includes an electronic control unit (ECU) 20, a storage unit 22, an accelerator actuator 24, a brake actuator 26, a car navigation device 28, a speaker 30, a GPS communication unit 32, an in-vehicle camera 34, an infrastructure communication unit 38, a vehicle speed sensor 40, and a display device 42. The ECU 20, the storage unit 22, the accelerator actuator 24, the brake actuator 26, the car navigation device 28, the speaker 30, the GPS communication unit 32, the in-vehicle camera 34, the infrastructure communication unit 38, the vehicle speed sensor 40, and the display device 42 constitute the driving assistance apparatus 19 of the vehicle 10. In addition to the parts described above, the vehicle 10 includes various parts typically provided in a vehicle, such as a vehicle body, a drive source, a brake apparatus, operating units (a steering wheel, an accelerator pedal, and a brake pedal, for example), and so on.

The ECU 20 controls the respective parts of the vehicle 10, the accelerator actuator 24, the brake actuator 26, the car navigation device 28, the speaker 30, the GPS communication unit 32, the in-vehicle camera 34, the infrastructure communication unit 38, the vehicle speed sensor 40, the display device 42, and so on. The ECU 20 controls operations of the respective parts on the basis of information obtained by the GPS communication unit 32, the in-vehicle camera 34, the infrastructure communication unit 38, and the vehicle speed sensor 40, and operations by a driver or the like input from various operating units such as the accelerator pedal, brake pedal, and so on, not shown in the drawing. Further, the ECU 20 includes a target vehicle speed control unit 20a. The target vehicle speed control unit 20a will be described below.

The storage unit 22 is a storage device such as a memory. The storage unit 22 stores conditions and data required for various processing performed by the ECU 20, and various programs executed by the ECU 20. The storage unit 22 also stores a map information database 22a. The map information database 22a stores information required for vehicle travel (maps, straight roads, curves, uphill and downhill slopes, expressways, sag zones, tunnels, and so on). The map information database 22a includes a map data file, an intersection data file, a node data file, and a road data file. The ECU 20 reads required information by referring to the map information database 22a.

The accelerator actuator 24 controls an output of a power supply of the vehicle 10 such as an engine or a motor. For example, the accelerator actuator 24 controls an amount of intake air taken into the engine, an intake timing and an ignition timing, a voltage value and a frequency of electric power supplied to the motor, and so on. The accelerator actuator 24 is electrically connected to the ECU 20 such that an operation of the accelerator actuator 24 is controlled by the ECU 20. The ECU 20 activates the accelerator actuator 24 in response to an accelerator control signal in order to adjust the amount of intake air taken into the engine, the intake timing and ignition timing, and the voltage value and frequency of electric power supplied to the motor. In other words, the accelerator actuator 24 is a device for automatically controlling a driving force generated by the power supply, which, by driving various parts upon reception of the accelerator control signal output from the ECU 20, controls driving conditions such that a desired driving force is generated. By controlling the driving force acting on the vehicle 10 in this manner, the accelerator actuator 24 adjusts an acceleration.

The brake actuator 26 controls driving of the brake apparatus installed in the vehicle 10. For example, the brake actuator 26 controls an oil pressure of a wheel cylinder provided in the brake apparatus. The brake actuator 26 is electrically connected to the ECU 20 such that an operation thereof is controlled by the ECU 20. The ECU 20 activates the brake actuator 26 in response to a brake control signal in order to adjust the brake oil pressure of the wheel cylinder. In other words, the brake actuator 26 is a device for automatically controlling a braking force generated by a brake, which, by driving a solenoid, a motor, or the like of a mechanism that supplies working oil to the wheel cylinder upon reception of the brake control signal output from the ECU 20, controls the brake oil pressure such that a desired braking force is generated. By controlling the braking force acting on the vehicle 10 in this manner, the brake actuator 26 adjusts a deceleration.

The car navigation device 28 guides the vehicle 10 to a desired destination. The car navigation device 28 is capable of bidirectional communication with the ECU 20. The car navigation device 28 includes a display unit that displays peripheral map information on the basis of the information stored in the map information database 22a and current position information obtained by the GPS communication unit 32, to be described below. Further, the car navigation device 28 detects a route to the destination on the basis of the information stored in the map information database 22a, the current position information obtained by the GPS communication unit 32 to be described below, and destination information input by the driver or the like, and displays information relating to the detected route on the display unit. The car navigation device 28 may include its own map information database and GPS communication unit separately from the map information database 22a and the GPS communication unit 32. In this case, the car navigation device 28 may be configured to perform route guidance and provide notification of the current position information using its own units.

The speaker 30 outputs audio to a vehicle interior of the vehicle 10. The speaker 30 outputs audio corresponding to an audio signal transmitted from the ECU 20 to the vehicle interior.

The GPS communication unit 32 receives GPS signals output respectively from the plurality of GPS satellites 16. The GPS communication unit 32 transmits the received GPS signals to the ECU 20. The ECU 20 detects position information relating to the host apparatus by analyzing the plurality of received GPS signals.

The in-vehicle camera 34 is an imaging device disposed on a front portion of the vehicle 10. The in-vehicle camera 34 obtains an image of the front (an advancement direction side) of the vehicle 10. The in-vehicle camera 34 transmits the obtained image of the front of the vehicle 10 to the ECU 20. The ECU 20 obtains information indicating a condition in front of the vehicle 10, more specifically whether or not another vehicle 10 is present in front of the vehicle 10, whether or not a traffic light 12, 12a is close, whether or not an intersection is close, and so on, by analyzing the image obtained by the in-vehicle camera 34.

The infrastructure communication unit 38 communicates wirelessly with the infrastructure information transmission apparatus 14 described above. The infrastructure communication unit 38 obtains infrastructure information transmitted from the infrastructure information transmission apparatus 14, and transmits the obtained infrastructure information to the ECU 20. The infrastructure communication unit 38 may obtain the infrastructure information by communicating constantly with an infrastructure information transmission apparatus 14 that is capable of communication, by communicating with the infrastructure information transmission apparatus 14 at fixed time intervals, or by communicating with a new infrastructure information transmission apparatus 14 when the information transmission apparatus 14 becomes capable of communication.

The vehicle speed sensor 40 detects a vehicle speed of the vehicle 10. The vehicle speed sensor 40 transmits information indicating the detected vehicle speed to the ECU 20.

The display device 42 displays various information to be imparted to the driver. The display device 42 is an instrument panel disposed on a dashboard of the vehicle 10, for example. The display device 42 may be a liquid crystal display device or a display device on which various measuring instruments are disposed. The display device 42 displays information such as a remaining amount of fuel, an output of the drive source (i.e. an engine rotation speed), an open/closed condition of a door, and a fastened/unfastened condition of a seatbelt. The display device 42 includes a vehicle speed display region 48 in which the vehicle speed is displayed.

As shown in FIG. 3, the vehicle speed display region 48 includes a scale display portion 50 and a needle 52. The scale display portion 50 takes an arc shape and includes a scale extending from 0 km/h to 160 km/h. The needle 52 indicates the vehicle speed obtained as the detection result, and in FIG. 3, the needle 52 indicates 40 km/h. The vehicle speed display region 48 is an analog meter on which the position indicated by the needle 52 varies in accordance with the current vehicle speed. Hence, by checking the position indicated by the needle 52 in the vehicle speed display region 48, the driver can acknowledge the detection result of the current vehicle speed.

Next, control executed by the target vehicle speed control unit (passage assistance control unit) 20a of the ECU 20 will be described. The target vehicle speed control unit 20a determines whether or not the vehicle 10 is permitted to pass through a subject traffic light location (a passage subject region, the passage subject intersection or pedestrian crossing at which the traffic light 12, 12a is disposed) on the basis of the information obtained by the respective parts of the vehicle 10. Further, having determined that the vehicle 10 is permitted to pass through the subject traffic light location, the target vehicle speed control unit 20a determines a vehicle speed region in which the vehicle 10 is permitted to pass through the subject traffic light location as a target vehicle speed region, and displays the determined target vehicle speed region in the vehicle speed display region 48 of the display device 42. More specifically, the target vehicle speed control unit 20a determines whether or not the vehicle 10 is able to pass through the traffic light location within a predetermined period (without stopping before the traffic light location) on the basis of the light cycle information obtained by the infrastructure communication unit 38, a distance between the vehicle 10 and the traffic light 12, 12a, and information indicating the current vehicle speed detected by the vehicle speed sensor 40. Here, the light cycle information is a traffic light information relating to the change in the display condition of the traffic light 12, 12a disposed at the traffic light location. The light cycle information includes the illumination cycle of the traffic light 12, 12a, the light change timing of the traffic light 12, 12a, and so on. The distance between the vehicle 10 and the traffic light 12, 12a is, to be precise, a distance between the vehicle 10 and the traffic light location at which the traffic light 12, 12a is disposed. The predetermined period is a period during which the traffic light 12, 12a is in a display condition (passage permitting display condition) indicating that passage of the vehicle 10 is permitted. The target vehicle speed control unit 20a, having determined that the vehicle 10 is permitted to pass through the subject traffic light location, calculates a travel speed region (the target vehicle speed region) required to pass the traffic light location while the traffic light 12, 12a is in the passage permitting display condition. The target vehicle speed control unit 20a may compare the travel speed region (in this case, a reference target vehicle speed region) required to pass the traffic light location while the traffic light 12, 12a is in the passage permitting display condition with the current vehicle speed, and determine the target vehicle speed region on the basis of the comparison result. The target vehicle speed control unit 20a then displays the calculated target vehicle speed region (recommended travel speed region) in the vehicle speed display region 48. In so doing, the target vehicle speed control unit 20a performs green wave assistance, which is control for providing the driver with vehicle speed guidance to reduce the number of times the vehicle 10 stops at a red light. In the display condition indicating that passage through the traffic light is permitted, the traffic light generates a display indicating that passage through a subject route is permitted. The passage permitting display condition is not limited to a condition in which the green light is displayed, and includes a condition in which the arrow light is displayed. A condition in which the yellow light is displayed may also be included in the passage permitting display condition.

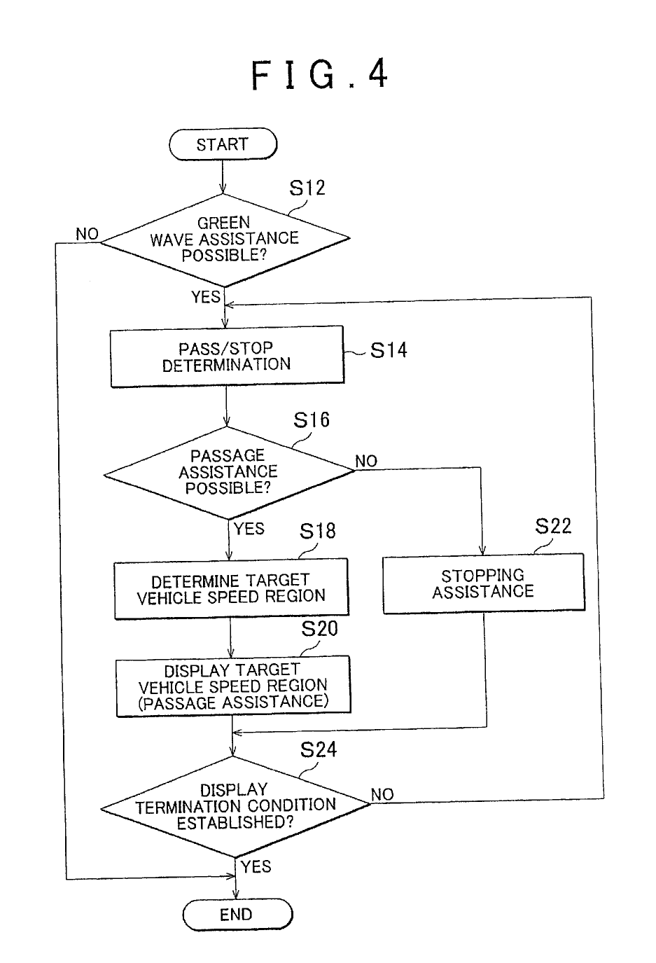

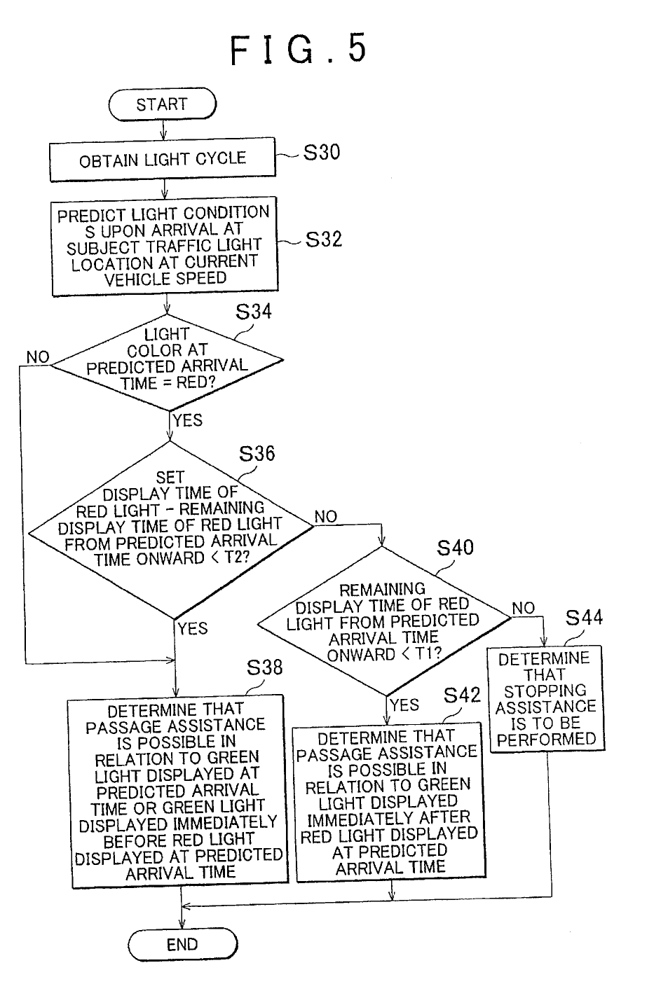

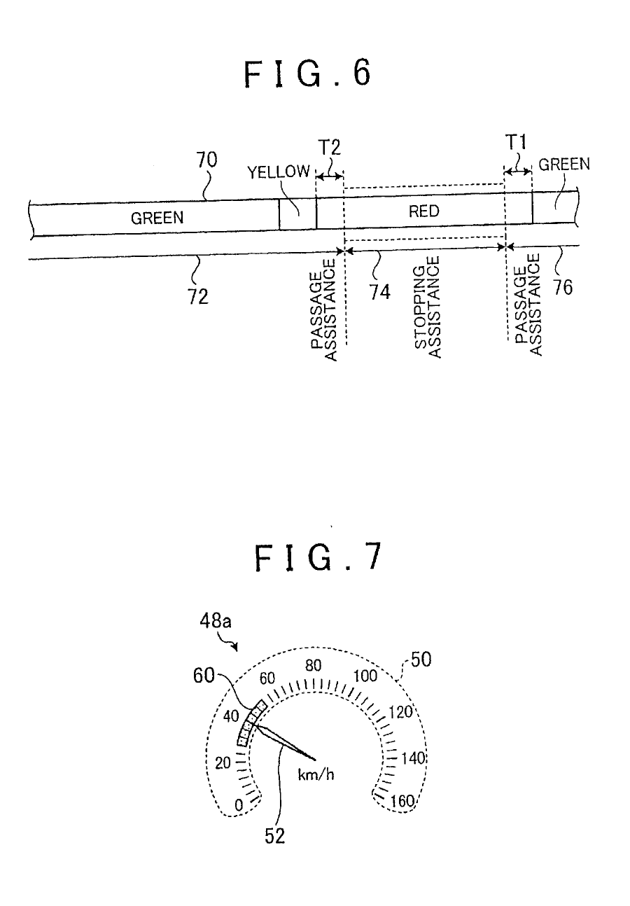

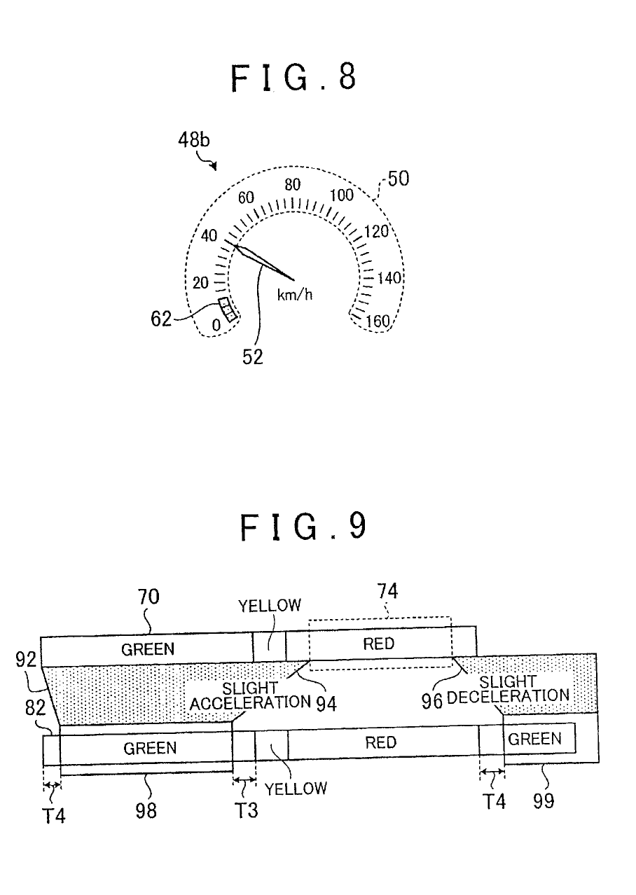

Next, using FIGS. 4 to 8, the control executed by the target vehicle speed control unit 20a in the ECU 20 of the vehicle 10 will be described in further detail. FIGS. 4 and 5 are flowcharts showing examples of the processing performed by the driving assistance apparatus. FIG. 6 is an illustrative view illustrating an example of determination processing performed during a passage determination. FIGS. 7 and 8 are schematic diagrams showing respective examples of the vehicle speed display region of the display device.

In Step S12, the target vehicle speed control unit 20a of the ECU 20 determines whether or not green wave assistance is possible. More specifically, the target vehicle speed control unit 20a determines whether or not information required to calculate the target vehicle speed region has been obtained and a condition enabling display of the target vehicle speed region is satisfied. The information required to calculate the target vehicle speed region is the infrastructure information including the illumination cycle, light change timing, and so on of the passage subject traffic light 12, 12a, the current position information required to calculate the distance between the vehicle 10 and the traffic light 12, 12a, and map information including information indicating the position of the traffic light 12, 12a. Further, the condition enabling display of the target vehicle speed region is satisfied when the distance between the vehicle 10 and the traffic light 12, 12a (the distance between the vehicle 10 and the traffic light location) equals or exceeds a fixed distance, the current vehicle speed of the vehicle 10 equals or exceeds a fixed vehicle speed, and so on. When the distance between the vehicle 10 and the traffic light location is smaller than the fixed distance, even if the target vehicle speed region is displayed, the driver cannot easily drive in accordance with the target vehicle speed region, and therefore the target vehicle speed control unit 20a determines that the green wave assistance is not possible. When the current vehicle speed of the vehicle 10 is lower than the fixed vehicle speed, it is likely that the vehicle speed of the vehicle 10 is restricted because congestion on the road on which the vehicle 10 is traveling, or it is likely that the vehicle 10 is about to stop, has already stopped, or the like for some reason. Therefore, when the current vehicle speed of the vehicle 10 is lower than the fixed vehicle speed, even if the target vehicle speed region is displayed, the driver cannot easily drive in accordance with the target vehicle speed region, and therefore the target vehicle speed control unit 20a determines that the green wave assistance is not possible. When the target vehicle speed control unit 20a determines in Step S12 that the green wave assistance is not possible (No), the processing is terminated.

Having determined in Step S12 that the green wave assistance is possible (Yes), the target vehicle speed control unit 20a performs a pass/stop determination in Step S14. Processing performed in the pass/stop determination will now be described using FIGS. 5 and 6. Note that in FIG. 5, for ease of description, a case in which the light color of the traffic light is green corresponds to the passage permitting display condition and a case in which the light color of the traffic light is red corresponds to a passage prohibiting display condition indicating that vehicle passage is prohibited (not permitted).

In Step S30, as shown in FIG. 5, the target vehicle speed control unit 20a obtains the light cycle information. In other words, the target vehicle speed control unit 20a obtains the light cycle information of a determination subject traffic light, which is normally the next traffic light to be passed. Having obtained the light cycle in Step S30, the target vehicle speed control unit 20a predicts, in Step S32, a light condition S at an arrival time at the subject traffic light location after traveling at the current vehicle speed. More specifically, the target vehicle speed control unit 20a predicts an arrival timing of the vehicle 10 at the traffic light location on the basis of the distance between the vehicle 10 and the subject traffic light 12, 12a, or more precisely the distance between the vehicle 10 and the traffic light location, and the current vehicle speed, and obtains the condition of the traffic light at the predicted timing as the light condition S on the basis of the predicted timing and the light cycle information. Here, the light condition S includes the light color of the traffic light upon arrival at the traffic light location, a display time of the displayed light color (an elapsed time from the start of display of the corresponding light color), and a time remaining until the traffic light changes to the next light color (a remaining display time of the displayed light color).

After predicting the light condition S upon arrival at the traffic light location in Step S32, the target vehicle speed control unit 20a determines in Step S34 whether or not the light color of the traffic light will be red, or in other words whether or not the light condition S will be a red light condition, at the predicted arrival time at the traffic light location. After determining in Step S34 that the light color of the traffic light at the predicted arrival time will not be red (No), the target vehicle speed control unit 20a advances to Step S38.

After determining in Step S34 that the light color of the traffic light at the predicted arrival time will be red (Yes), the target vehicle speed control unit 20a determines in Step S36 whether or not a time obtained by subtracting a remaining display time of the red light after the predicted arrival time from a set display time of the red light is shorter than a predetermined time T2. In other words, when the light color of the traffic light will be red at the predicted arrival time, the target vehicle speed control unit 20a determines whether or not an elapsed time from the change in the light color of the traffic light to red to the predicted arrival time is shorter than the second threshold time T2. Having determined in Step S36 that the time obtained by subtracting the remaining display time of the red light from the set display time of the red light is shorter than the second threshold time T2 (Yes), the target vehicle speed control unit 20a advances to Step S38.

When No is determined in Step S34 or Yes is determined in Step S36, or in other words when the light color of the traffic light at the predicted arrival time will be green or the light color of the traffic light at the predicted arrival time will be red and the elapsed time following the change in the light color of the traffic light to red is shorter than the second threshold time T2, the target vehicle speed control unit 20a determines in Step S38 that passage assistance can be performed in relation to the green light displayed at the predicted arrival time or a green light displayed immediately before the red light displayed at the predicted arrival time. More specifically, when the light color of the traffic light at the predicted arrival time will be green, the target vehicle speed control unit 20a determines that the vehicle 10 may pass through the traffic light location within the display period of the green light displayed at the predicted arrival time. When the light color of the traffic light at the predicted arrival time will be red and the elapsed time following the change in the light color of the traffic light to red is shorter than the second threshold time T2, the target vehicle speed control unit 20a determines that the vehicle 10 may pass through the traffic light location within the display period of the green light displayed immediately before the red light displayed at the predicted arrival time. After determining that the passage assistance is possible in Step S38, the target vehicle speed control unit 20a terminates the pass/stop determination processing of Step S14.

Further, after determining in Step S36 that the time obtained by subtracting the remaining display time of the red light from the set display time of the red light is not shorter than the second threshold time T2 (No), the target vehicle speed control unit 20a determines in Step S40 whether or not the remaining display time of the red light is shorter than a first threshold time T1. In other words, when the light color of the traffic light at the predicted arrival time is red, the target vehicle speed control unit 20a determines whether or not a time remaining until the light color of the traffic light changes from red to the next color (a light color indicating that vehicles is permitted to pass, basically green) following the predicted arrival time is shorter than the first threshold time T1. Having determined in Step S40 that the remaining display time of the red light is shorter than the first threshold time T1 (Yes), the target vehicle speed control unit 20a determines in Step S42 that passage assistance can be performed in relation to the green light to be displayed immediately after the red light displayed at the predicted arrival time. More specifically, when the light color of the traffic light at the predicted arrival time will be red and the time remaining until the light color of the traffic light changes to green following the predicted arrival time is shorter than the first threshold time T1, the target vehicle speed control unit 20a determines that the vehicle 10 may pass through the traffic light location within the display period of the green light to be displayed after the red light displayed at the predicted arrival time. After determining that the passage assistance is possible in Step S42, the target vehicle speed control unit 20a terminates the pass/stop determination processing of Step S14.

After determining in Step S40 that the remaining display time of the red light is not shorter than the predetermined time T1 (No), the target vehicle speed control unit 20a determines in Step S44 that stopping assistance is required. After determining that the stopping assistance is required in Step S44, the target vehicle speed control unit 20a terminates the pass/stop determination processing of Step S14.

Next, using FIG. 6, a relationship between the pass/stop determination processing shown in FIG. 5 and the light color of the traffic light at the predicted arrival time will be described. A light cycle 70 shown in FIG. 6 shows the light color of the traffic light at the predicted arrival time. In the light cycle 70, the light color changes from green to yellow, from yellow to red, and from red to green. Note that in the processing shown in FIG. 5, it is assumed that the yellow light is included in the green light. By performing the pass/stop determination using the processing shown in FIG. 5, the target vehicle speed control unit 20a determines that the passage assistance is to be performed when the predicted arrival time at the traffic light location is a time within a region 72 or a time within a region 76, and determines that the stopping assistance is to be performed when the predicted arrival time at the traffic light location is a time within a region 74. Here, the region 72 includes a region in which the light color of the traffic light is green or yellow and a region in which the time following a change in the light color of the traffic light to red is shorter than the second threshold time 12. The region 76 includes a region in which the light color of the traffic light is red and the time remaining until the light color changes from red to green is shorter than the first threshold time T1, and a region in which the light color of the traffic light has changed from red to green. Further, the region 74 corresponds to a region in which the light color is red, the time following the change in the light color to red equals or exceeds the second threshold time T2, and the time remaining until the light color of the traffic light changes from red to green equals or exceeds the first threshold time T1.

As shown in FIGS. 5 and 6, the target vehicle speed control unit 20a performs the passage assistance in the region 72. As a result, the passage assistance can be performed in a case where the light color of the traffic light upon arrival at the traffic light location will be red if the vehicle 10 travels at the current vehicle speed but green if the vehicle 10 accelerates from the current vehicle speed. Further, as shown in FIGS. 5 and 6, the target vehicle speed control unit 20a performs the passage assistance in the region 76. As a result, the passage assistance can be performed in a case where the light color of the traffic light upon arrival at the traffic light location will be red if the vehicle 10 travels at the current vehicle speed but green if the vehicle 10 decelerates from the current vehicle speed.

Returning to FIG. 4, description of the flowchart will be continued. After performing the pass/stop determination in Step S14, the target vehicle speed control unit 20a determines in Step S16 whether or not the passage assistance is possible, or in other words whether or not it has been determined in Step S14 that the passage assistance is to be performed. After determining in Step S16 that the passage assistance is possible (Yes), or in other words when it is determined in Step S14 that the passage assistance is to be performed, the target vehicle speed control unit 20a determines the target vehicle speed region in Step S18. In other words, the target vehicle speed control unit 20a calculates a vehicle speed region in which the vehicle 10 is able to pass through the traffic light location within the display period of the green light (the green light display period) determined as the passage assistance subject in Step S14, and sets the calculated vehicle speed region as the target vehicle speed region. The target vehicle speed control unit 20a may adjust the target vehicle speed region displayed in the vehicle speed display region 48 on the basis of the calculated vehicle speed region (a reference target vehicle speed region), the current vehicle speed, and a preset condition. For example, the target vehicle speed control unit 20a sets an upper limit value (an upper limit displayed vehicle speed) of the target vehicle speed region at a speed no higher than a speed obtained by adding a predetermined vehicle speed α to the current vehicle speed.

After determining the target vehicle speed region in Step S18, the target vehicle speed control unit 20a executes the passage assistance in Step S20. As the passage assistance, the target vehicle speed control unit 20a displays the determined target vehicle speed region in the vehicle speed display region 48. For example, the target vehicle speed control unit 20a displays a vehicle speed display region 48a shown in FIG. 7. In the vehicle speed display region 48a, a mark 60 is displayed over a vehicle speed region that overlaps the target vehicle speed region in the scale display portion 50. In this embodiment, the target vehicle speed region is 30 km/h to 50 km/h, and therefore the mark 60 is displayed in a vehicle speed region extending from 30 km/h to 50 km/h. Note that when the scale display portion 50 is displayed as an image in a liquid crystal display device, the vehicle speed display region 48a may be formed by overlapping an image of the mark 60 onto the image of the scale display portion 50. Further, when the scale display portion 50 is drawn using ink or the like, the vehicle speed display region 48a may be formed by disposing a light emitting portion in a part of the scale display portion 50 depicting the scale and displaying the mark 60 by illuminating a part of the light emitting portion corresponding to the target vehicle speed region. By displaying the determined target vehicle speed region in the form of the mark 60 overlapped onto the scale display portion 50 in this manner, the target vehicle speed control unit 20a can cause a user to acknowledge the determined target vehicle speed region. After performing the processing of Step S20, the target vehicle speed control unit 20a advances to Step S24.

Having determined in Step S16 that the passage assistance is not possible (No), or in other words when it is determined in Step S14 that the stopping assistance is required, the target vehicle speed control unit 20a executes the stopping assistance in Step S22. In the stopping assistance, a speed region in the vicinity of 0 km/h is displayed as the target vehicle speed region. For example, the target vehicle speed control unit 20a displays a vehicle speed display region 48b shown in FIG. 8. In the vehicle speed display region 48b, a mark 62 is displayed over a vehicle speed region that overlaps the target vehicle speed region in the scale display portion 50. Here, the target vehicle speed region is a vehicle speed region in the vicinity of 0 km/h (a vehicle speed region including 0 km/h, in this embodiment 0 km/h to 10 km/h), and therefore the mark 62 is displayed in a vehicle speed region in the vicinity of 0 km/h. By displaying the determined target vehicle speed region in the form of the mark 62 overlapped onto the scale display portion 50 in this manner, the target vehicle speed control unit 20a can cause the user to acknowledge the determined target vehicle speed region. Hence, in Step S22, the user can acknowledge that stoppage of the vehicle 10 is recommended. After performing the processing of Step S22, the target vehicle speed control unit 20a advances to Step S24.

After performing the processing of Step S20 or the processing of Step S22, the target vehicle speed control unit 20a determines whether or not a display termination condition is established in Step S24. Here, the display termination condition is a preset condition for terminating display of the target vehicle speed region. The display termination condition is established when, for example, the distance between the vehicle and the subject traffic light location falls to or below a fixed value, the vehicle speed departs from a fixed region, a fixed amount of time elapses following display of the target vehicle speed region, or similar. Having determined in Step S24 that the display termination condition is not established (No), the target vehicle speed control unit 20a advances to Step S14 and repeats the processing described above. In other words, the target vehicle speed region is recalculated and displayed again. Having determined in Step S24 that the display termination condition is established (Yes), the target vehicle speed control unit 20a terminates the processing.

Hence, by performing the pass/stop determination on the basis of the processing shown in FIGS. 5 and 6, the driving assistance apparatus 19 (as well as the vehicle 10 and the driving assistance system 1 including the driving assistance apparatus 19) can perform the passage assistance in a case where the light color of the traffic light upon arrival at the traffic light location will be red if the vehicle 10 travels at the current vehicle speed but green if the vehicle 10 accelerates from the current vehicle speed. As a result, the passage assistance can be performed favorably in a case where it is possible to pass through the traffic light location by accelerating within a predetermined range, and therefore the driver can be notified of a favorable target vehicle speed region. Further, the driver can be prevented from suspecting that it would have been possible to pass through the traffic light location by accelerating slightly more, and therefore the passage assistance can be performed in a manner that is unlikely to cause the driver to feel a sense of distrust therein.

By performing the pass/stop determination on the basis of the processing shown in FIGS. 5 and 6, the driving assistance apparatus 19 can perform the passage assistance in a case where the light color of the traffic light upon arrival at the traffic light location will be red if the vehicle 10 travels at the current vehicle speed but green if the vehicle 10 decelerates from the current vehicle speed. As a result, the passage assistance can be performed favorably in a case where it is possible to pass through the traffic light location by decelerating within a predetermined range, and therefore the driver can be notified of a favorable target vehicle speed region. Further, the driver can be prevented from suspecting that it would have been possible to pass through the traffic light location by decelerating slightly more, and therefore the passage assistance can be performed in a manner that is unlikely to cause the driver to feel a sense of distrust therein.

By performing the pass/stop determination on the basis of the processing shown in FIGS. 5 and 6, the driving assistance apparatus 19 can perform the pass/stop determination on the basis of the current vehicle speed, the light cycle information, and the predicted arrival time at the traffic light location. As a result, the pass/stop determination can be performed through simple processing.

Further, the driving assistance apparatus 19 preferably adjusts and determines the first threshold times T1 and the second threshold time T2 used in the pass/stop determination, or in other words times at which the passage assistance is performed even when the light color of the traffic light at the predicted arrival time is red, in accordance with the distance between the vehicle and the traffic light location. In so doing, the driving assistance apparatus 19 can modify the reference of the pass/stop determination in accordance with the distance between the vehicle and the traffic light location, whereby the pass/stop determination can be executed more appropriately. More specifically, the first threshold times T1 and the second threshold time T2 are preferably lengthened as the distance between the vehicle and the traffic light location increases and shortened as the distance between the vehicle and the traffic light location decreases. For example, when the distance between the vehicle and the traffic light location is D, each of the first threshold times T1 and the second threshold time T2 may be determined by multiplying the distance D by a coefficient. In so doing, the first threshold times T1 and the second threshold time T2 can be increased as the distance D increases, and as a result, the time period in which it is determined that the vehicle is permitted to pass through the traffic light location even though the light color of the traffic light at the predicted arrival time is red can be increased. Hence, it is more likely to be determined that the vehicle is permitted to pass through the traffic light location in a situation that the vehicle speed can be adjusted easily, and therefore the vehicle is more likely to be able to pass through the traffic light location without stopping.

In this embodiment, a stopping assistance target vehicle speed region is displayed as the stopping assistance, but an embodiment employed when the passage assistance cannot be performed is not limited thereto, and instead of the processing of Step S22, the driving assistance apparatus 19 may refrain from displaying a target vehicle speed region when the passage assistance is impossible.

The driving assistance apparatus 19 may calculate the target vehicle speed region using various references. The driving assistance apparatus 19 preferably calculates, as the target vehicle speed region, a vehicle speed region in which the vehicle may pass through the traffic light location between a point following the elapse of a predetermined time after a change in the display condition of the traffic light from the passage prohibiting display condition (a condition in which the light color of the traffic light is red, for example) to the passage permitting display condition (a condition in which the light color of the traffic light is green, for example) and a point preceding, by the threshold time, a change in the display condition of the traffic light from the passage permitting display condition (the condition in which the light color of the traffic light is green, for example) to the passage prohibiting display condition (the condition in which the light color of the traffic light is red, for example).

Next, description will be continued using FIG. 9. FIG. 9 is an illustrative view illustrating an example of target vehicle speed region determination processing. The light cycle 70 shown in FIG. 9 is identical to the light cycle 70 shown in FIG. 6, described above. When the predicted arrival time is outside the region 74, the driving assistance apparatus 19 executes the passage assistance and calculates the target vehicle speed region. Here, a light cycle 82 is a subject light cycle using during calculation of the target vehicle speed region. In the light cycle 82, similarly to the light cycle 70, the light color changes from green to yellow, from yellow to red, and from red to green.

A correspondence relationship between the light cycle 70 and the light cycle 82 is as follows. When the target vehicle speed is set at the current vehicle speed, the light cycle 82 is identical the light cycle 70 at the predicted time. Further, as shown by straight lines 92, 96, when the target vehicle speed is set at a lower speed than the current vehicle speed, the light cycle 82 is a light cycle later than the predicted time of the light cycle 70. In other words, when the target vehicle speed is set at a lower speed than the current vehicle speed, the vehicle 10 arrives at the traffic light location at a later time than the predicted arrival time at the traffic light location. Further, as shown by a straight line 94, when the target vehicle speed is set at a higher speed than the current vehicle speed, the light cycle 82 is a light cycle earlier than the predicted time of the light cycle 70. In other words, when the target vehicle speed is set at a higher speed than the current vehicle speed, the vehicle 10 arrives at the traffic light location at an earlier time than the predicted arrival time at the traffic light location.

When calculating the target vehicle speed region, the driving assistance apparatus 19 preferably calculates a vehicle speed region in which the vehicle 10 is able to reach the traffic light location at a timing within a region 98 or a timing within a region 99 in the light cycle 82 as the target vehicle speed region. The regions 98, 99 are time regions in which the light color of the traffic light is green, the time remaining to a change in the light color of the traffic light from green to red equals or exceeds a third threshold time T3, and the time following the change in the light color of the traffic light to green equals or exceeds a fourth threshold time T4. By having the driving assistance apparatus 19 set the target vehicle speed region at a vehicle speed region in which the remaining time until the light color of the traffic light changes from green to red equals or exceeds the third threshold time T3 in this manner, the vehicle can pass through the traffic light location before the light color of the traffic light changes to red even when the vehicle decelerates to a vehicle speed below the target vehicle speed region during actual travel such that slightly more time is required to reach the traffic light location. Further, by having the driving assistance apparatus 19 set the target vehicle speed region at a vehicle speed region in which the time following the change in the light color of the traffic light to green equals or exceeds the fourth threshold time T4, the light color of the traffic light changes from red to green at point having a given distance to the traffic light location. As a result, the vehicle can be prevented from approaching the traffic light while the light color is still red. Hence, a situation in which the driver is uncertain whether the light color will change and therefore considers decelerating can be suppressed, and the driver can thus be prevented from feeling a sense of discomfort.

The driving assistance apparatus 19 preferably adjusts and determines the third threshold time T3 and the fourth threshold time T4 used during calculation of the target vehicle speed region, or in other words times not subject to target vehicle speed region calculation within the time during which the light color of the traffic light is green at the predicted arrival time at the traffic light location, in accordance with the distance between the vehicle and the traffic light location. In so doing, similarly to the first threshold time T1 and the second threshold time T2, processing can be executed favorably in accordance with the distance.

When the light color of the traffic light is green at the predicted arrival time at the traffic light location, for example, the driving assistance apparatus 19 may calculate an upper limit vehicle speed Vbu and a lower limit vehicle speed Vbl of the target vehicle speed region using following equations.

Vbu=D/(Tv−(Tb−T4−Ts))

Vbl=D/(Tv+(Ts−T3))

Here, D represents the distance from the vehicle to the traffic light location, Tv represents the time required to reach the traffic light location at the current vehicle speed, and Ts represents the time remaining until the light color upon arrival at the traffic light location changes to the next light color. Further, Tb represents the time during which the light color of the traffic light is green according to the light cycle.

When the light color of the traffic light is yellow at the predicted arrival time at the traffic light location, the driving assistance apparatus 19 may calculate an upper limit vehicle speed Vyu and a lower limit vehicle speed Vyl of the target vehicle speed region using following equations.

Vyu=D/(Tv−(Tb−T4+Ty−Ts))

Vyl=D/(Tv−(T3+Ty−Ts))

Here, Ty represents the time during which the light color of the traffic light is yellow according to the light cycle.

When the light color is red at the predicted arrival time, the driving assistance apparatus 19 may calculate an upper limit vehicle speed Tru and a lower limit vehicle speed Trl of the target vehicle speed region using following equations.

Tru=D/(Tv−(Tb−T4+Ty+Tr−Ts))

Trl=D/(Tv−(T3+Ty+Tr−Ts))

Here, Tr represents the time during which the light color of the traffic light is red according to the light cycle.

The driving assistance apparatus 19 may calculate the target vehicle speed region using various references. The driving assistance apparatus 19 may set a vehicle speed that is higher than the current vehicle speed by a predetermined vehicle speed α as the upper limit vehicle speed of the target vehicle speed region. By setting a vehicle speed that is higher than the current vehicle speed by the predetermined vehicle speed α as the upper limit vehicle speed, the driving assistance apparatus 19 can suppress an increase in the amount of acceleration required to realize a vehicle speed within the target vehicle speed region. As a result, the vehicle 10 and the driving assistance apparatus 19 can notify of a target vehicle speed region that is unlikely to cause the driver to feel discomfort and stress.

The driving assistance apparatus 19 according to this embodiment sets a vehicle speed that is higher than the current vehicle speed by the predetermined vehicle speed α as the upper limit vehicle speed of the target vehicle speed region, but is not limited thereto. Further, a reference vehicle speed for determining whether or not the passage assistance is possible may be determined using various references to be described below, similarly to the upper limit vehicle speed of the target vehicle speed region. Here, the driving assistance apparatus 19 may set the upper limit vehicle speed of the target vehicle speed region at a value obtained by adding the current vehicle speed to a product of an acceleration G and a time t. In other words, the driving assistance apparatus 19 may set the upper limit vehicle speed at a vehicle speed that can be realized at the acceleration G in t seconds. Here, t seconds may take a value that varies on the basis of the distance to the traffic light location and the current vehicle speed. For example, the time t may be increased when the distance to the traffic light location is long and reduced when the distance to the traffic light location is short.

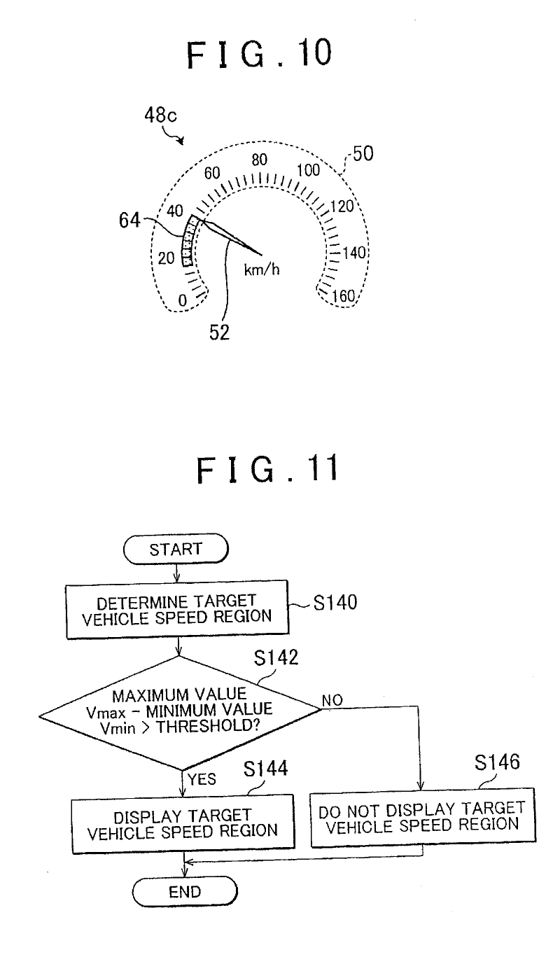

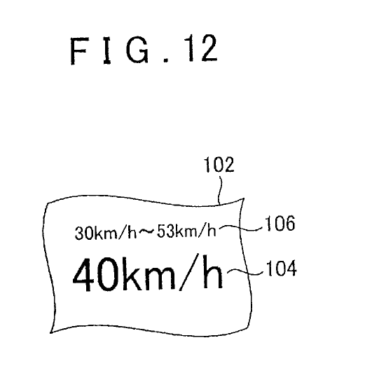

Further, the driving assistance apparatus 19 according to this embodiment may set the upper limit vehicle speed of the target vehicle speed region at the current vehicle speed. Here, FIG. 10 is a schematic diagram showing an example of the vehicle speed display region of the display device. A vehicle speed display region 48c shown in FIG. 10 displays a mark 64 in a vehicle speed region that overlaps the target vehicle speed region in the scale display portion 50. In the vehicle speed display region 48c shown in FIG. 10, the upper limit vehicle speed of the target vehicle speed region is set at the current vehicle speed. In the vehicle speed display region 48c, the current vehicle speed is 40 km/h, as shown by the needle 52, and therefore the upper limit vehicle speed of the target vehicle speed region is 40 km/h. Further, the target vehicle speed region extends from 20 km/h to 40 km/h, and therefore, in the vehicle speed display region 48c, the mark 64 is displayed in a vehicle speed region extending from 20 km/h to 40 km/h. By setting the upper limit vehicle speed of the target vehicle speed region at the current vehicle speed in this manner, the target vehicle speed control unit 20a can set the target vehicle speed region in a vehicle speed region where acceleration is not required. As a result, the driving assistance apparatus 19 does not recommend a target vehicle speed region requiring acceleration to the driver, and therefore a target vehicle speed region that is unlikely to cause the driver to feel discomfort and stress can be displayed. Note that when the pass/stop determination is implemented on the basis of the first threshold time T1 described above, acceleration is required to pass through the traffic light location. In this case, the driving assistance apparatus 19 sets the upper limit vehicle speed of the target vehicle speed region at a higher vehicle speed than the current vehicle speed.

The driving assistance apparatus 19 according to the above embodiment determines the upper limit vehicle speed of the target vehicle speed region using the current vehicle speed. However, the driving assistance apparatus 19 is not limited thereto, and may use a vehicle speed limit of the road on which the vehicle is traveling as the upper limit vehicle speed of target vehicle speed region. Here, the vehicle speed limit is a legal vehicle speed limit of the road on which the vehicle is currently traveling, for example. The vehicle speed limit may be obtained from the infrastructure information obtained by the infrastructure communication unit 38. Alternatively, the current position may be detected from the GPS signals received by the GPS communication unit 32, and the vehicle speed limit may be obtained from information corresponding to the current position, stored in the map information database 22a. The driving assistance apparatus 19 may use a combination of the infrastructure communication unit 38, the GPS communication unit 32, and the map information database 22a as an information acquisition unit for obtaining vehicle speed limit information. Another function of the driving assistance apparatus 19, for example the in-vehicle camera 34, may also be used as the information acquisition unit for obtaining the vehicle speed limit information. The driving assistance apparatus 19 may obtain an image of a sign disposed on the road along which the vehicle is traveling using the in-vehicle camera 34, and obtain the legal vehicle speed limit indicated by the image of the sign as the vehicle speed limit. By using the vehicle speed limit as the upper limit vehicle speed, the driving assistance apparatus 19 can prevent the target vehicle speed region display from exceeding the vehicle speed limit. Accordingly, the driving assistance apparatus 19 can display a vehicle speed no higher than the vehicle speed limit as the target vehicle speed region, and therefore a situation where a vehicle speed at which the vehicle 10 is not actually permitted to travel is displayed can be suppressed. As a result, a target vehicle speed region that is unlikely to cause the driver to feel discomfort and stress can be displayed.

The upper limit vehicle speed of the target vehicle speed region is more preferably determined using both the current vehicle speed and the vehicle speed limit. In other words, the driving assistance apparatus 19 preferably ensures that the target vehicle speed region does not exceed the vehicle speed limit when determining the upper limit vehicle speed of the target vehicle speed region. In so doing, the driving assistance apparatus 19 can realize both of the above effects, and as a result, a target vehicle speed region that is unlikely to cause the driver to feel discomfort and stress can be displayed.

The driving assistance apparatus 19 preferably displays the mark of the target vehicle speed region in different colors during the passage assistance and the stopping assistance. Note that the mark may be displayed in different patterns, different illumination conditions, and so on rather than in different colors. In so doing, the driver can immediately recognize whether the target vehicle speed region of the passage assistance or the target vehicle speed region of the stopping assistance is being displayed.

Next, using FIG. 11, another example of the processing performed by the driving assistance apparatus will be described. Here, FIG. 11 is a flowchart showing another example of the processing performed by the driving assistance apparatus. The processing shown in FIG. 11 is executed instead of Step S18 and Step S20 in FIG. 4. In other words, the processing shown in FIG. 11 is executed when Yes is determined in Step S16 of FIG. 4, and when this processing is complete, the routine advances to Step S24.

In Step S140, the target vehicle speed control unit 20a in the ECU 20 of the driving assistance apparatus 19 determines the target vehicle speed region. After determining the target vehicle speed region in Step S140, the target vehicle speed control unit 20a determines in Step S142 whether or not a difference obtained by subtracting a minimum value Vmin of the target vehicle speed region from a maximum value Vmax of the target vehicle speed region is larger than a threshold. Having determined in Step S142 that the difference obtained by subtracting the minimum value Vmin from the maximum value Vmax is larger than the threshold (Yes), the target vehicle speed control unit 20a displays the determined target vehicle speed region in the vehicle speed display region in Step S144. Following the processing of Step S144, the target vehicle speed control unit 20a terminates the processing.

Having determined in Step S142 that the difference obtained by subtracting the minimum value Vmin from the maximum value Vmax is not larger than the threshold (No), or in other words that the difference obtained by subtracting the minimum value Vmin from the maximum value Vmax is equal to or smaller than the threshold, the target vehicle speed control unit 20a keeps the determined target vehicle speed region from display in Step S146, or in other words does not display the target vehicle speed region in the vehicle speed display region. Following the processing of Step S146, the target vehicle speed control unit 20a terminates the processing.

As shown in FIG. 11, when the difference obtained by subtracting the minimum value Vmin of the target vehicle speed region from the maximum value Vmax of the target vehicle speed region is equal to or smaller than the threshold, the driving assistance apparatus 19 does not display the target vehicle speed region. As a result, a narrow target vehicle speed region in which vehicle speed adjustment is difficult can be kept from display. Thus, the driving assistance apparatus 19 can selectively display wide target vehicle speed regions in which vehicle speed adjustment is comparatively easy, and therefore target vehicle speed regions that are less likely to cause the driver to feel discomfort and stress can be displayed.

Further, in the driving assistance apparatus 19 according to the above embodiments, the vehicle speed display displayed in the vehicle speed display region 48 of the display device 42 is an analog meter, but is not limited thereto, and instead, the vehicle speed display displayed in the vehicle speed display region 48 of, the display device 42 of the driving assistance apparatus 19 may be a digital meter. Here, FIG. 16 is a schematic diagram showing another example of the vehicle speed display region of the display device. A vehicle speed display region 102 is a display mechanism that displays vehicle speeds in numerals, and includes a first region 104 and a second region 106. The first region 104 is a region for displaying the current vehicle speed. In the first region 104 in FIG. 16, “20 km/h” is displayed. The second region 106 is a region on an upper side of a screen, above the first region 104, for displaying the target vehicle speed region. In the second region 106 in FIG. 16, “30 km/h-53 km/h” is displayed. Thus, the driving assistance apparatus 19 can obtain similar effects to those described above when the vehicle speed display region 102 of the display device 42 is displayed in the form of a digital meter. Here, the driving assistance apparatus 19 preferably displays the current vehicle speed displayed in the first region 104 of the vehicle speed display region 102 and the target vehicle speed region displayed in the second region 106 in different colors and/or different sizes. In so doing, the driving assistance apparatus 19 can prevent the driver from confusing the current vehicle speed and the target vehicle speed region.

The driving assistance apparatus 19 preferably performs the pass/stop determination using the processing shown in FIG. 5 and calculates the target vehicle speed region on the basis of the relationship shown in FIG. 9. However, the driving assistance apparatus 19 is not limited thereto, and may perform the pass/stop determination using the processing shown in FIG. 5 and calculate the target vehicle speed region on the basis of a relationship other than the relationship shown in FIG. 9. For example, the driving assistance apparatus 19 may set a vehicle speed region in which the vehicle 10 is able to pass through the traffic light location throughout the entire period during which the light color of the traffic light is green or the entire period during which the light color of the traffic light is green and yellow as the target vehicle speed region. The pass/stop determination can likewise be executed favorably in this case, and therefore the effects described above can be obtained.

The driving assistance apparatus 19 may execute the passage assistance determination using processing other than the processing shown in FIG. 5, and calculate the target vehicle speed region on the basis of the relationship shown in FIG. 9. For example, the pass/stop determination may be performed on the basis of whether or not the vehicle speed region determined on the basis of the relationship shown in FIG. 9 is a predetermined vehicle speed region, for example a vehicle speed region within the vehicle speed limit. The target vehicle speed region can likewise be calculated favorably in this case, and therefore the effects described above can be obtained.

What is claimed is:

1. A driving assistance apparatus that assists driving of a vehicle, comprising:
a vehicle speed sensor that detects a vehicle speed of the vehicle;
a communication unit that obtains light information relating to a change in a display condition of a traffic light disposed in an advancement direction of the vehicle;
a position calculation unit that calculates relative position information between the vehicle and a traffic light location where the traffic light is disposed; and
a target vehicle speed determination unit that obtains, on the basis of a current vehicle speed detected by the vehicle speed sensor, the relative position information between the vehicle and the traffic light location, calculated by the position calculation unit, and the light information obtained by the communication unit, an arrival timing at the traffic light location following travel at the current vehicle speed, and that determines a vehicle speed region in which the vehicle is permitted to pass through the traffic light location as a target vehicle speed region when the display condition of the traffic light at the arrival timing corresponds to a passage permitting display condition in which vehicle passage is permitted, or when the display condition of the traffic light at the arrival timing corresponds to a passage non-permitting display condition indicating that the vehicle passage is not permitted and a time remaining from the arrival timing until the display condition of the traffic light changes from the passage non-permitting display condition to the passage permitting display condition is within a first threshold time.

2. The driving assistance apparatus according to claim 1, wherein the target vehicle speed determination unit determines, as the target vehicle speed region, a vehicle speed region required to pass through the traffic light location following a change in the display condition of the traffic light from the passage non-permitting display condition to the passage permitting display condition when the display condition of the traffic light at the arrival timing corresponds to the passage non-permitting display condition and the time remaining from the arrival timing until the display condition of the traffic light changes from the passage non-permitting display condition to the passage permitting display condition is within the first threshold time.

3. The driving assistance apparatus according to claim 1, wherein the target vehicle speed determination unit determines to assist stopping of the vehicle at the traffic light location when the arrival timing is between a point after a second threshold time elapses following a change from the passage permitting display condition to the passage non-permitting display condition and a point preceding, by the first threshold time, a change from the passage non-permitting display condition to the passage permitting display condition.

4. The driving assistance apparatus according to claim 1, wherein the target vehicle speed determination unit lengthens the first threshold time as a distance between the vehicle and the traffic light location, calculated by the position calculation unit, increases and shortens the first threshold time as the distance between the vehicle and the traffic light location, calculated by the position calculation unit, decreases.

5. The driving assistance apparatus according to claim 1, wherein the target vehicle speed determination unit calculates, as the target vehicle speed region, a vehicle speed region required to pass through the traffic light location between a point following the elapse of a fourth threshold time after a change in the display condition of the traffic light from the passage non-permitting display condition to the passage permitting display condition and a point preceding, by a third threshold time, a change in the display condition of the traffic light from the passage permitting display condition to the passage non-permitting display condition.

6. The driving assistance apparatus according to claim 1, wherein the target vehicle speed determination unit calculates, as the target vehicle speed region, a vehicle speed region required to pass through the traffic light location while the display condition of the traffic light corresponds to the passage permitting display condition.

7. The driving assistance apparatus according to claim 1, further comprising:
a target vehicle speed notification unit that notifies of the target vehicle speed region determined by the target vehicle speed determination unit.

8. A driving assistance apparatus that assists driving of a vehicle, comprising:
a vehicle speed sensor that detects a vehicle speed of the vehicle;
a communication unit that obtains light information relating to a change in a display condition of a traffic light disposed in an advancement direction of the vehicle;
a position calculation unit that calculates relative position information between the vehicle and a traffic light location where the traffic light is disposed; and
a target vehicle speed determination unit that obtains, on the basis of a current vehicle speed detected by the vehicle speed sensor, the relative position information between the vehicle and the traffic light location, calculated by the position calculation unit, and the light information obtained by the communication unit, an arrival timing at the traffic light location following travel at the current vehicle speed, and that determines a vehicle speed region in which the vehicle is permitted to pass through the traffic light location as a target vehicle speed region when the display condition of the traffic light at the arrival timing corresponds to a passage permitting display condition indicating that vehicle passage is permitted, or when the display condition of the traffic light at the arrival timing corresponds to a passage non-permitting display condition indicating that the vehicle passage is not permitted and an elapsed time following a change in the display condition of the traffic light from the passage permitting display condition to the passage non-permitting display condition up to the arrival timing is within a second threshold time.

9. The driving assistance apparatus according to claim 8, wherein the target vehicle speed determination unit determines to assist stopping of the vehicle at the traffic light location when the arrival timing is between a point after the second threshold time elapses following a change from the passage permitting display condition to the passage non-permitting display condition and a point preceding, by a first threshold time, a change from the passage non-permitting display condition to the passage permitting display condition.

10. The driving assistance apparatus according to claim 8, wherein the target vehicle speed determination unit lengthens the second threshold time as a distance between the vehicle and the traffic light location, calculated by the position calculation unit, increases and shortens the second threshold time as the distance between the vehicle and the traffic light location, calculated by the position calculation unit, decreases.

11. The driving assistance apparatus according to claim 8, wherein the target vehicle speed determination unit calculates, as the target vehicle speed region, a vehicle speed region required to pass through the traffic light location between a point following the elapse of a fourth threshold time after a change in the display condition of the traffic light from the passage non-permitting display condition to the passage permitting display condition and a point preceding, by a third threshold time, a change in the display condition of the traffic light from the passage permitting display condition to the passage non-permitting display condition.

12. The driving assistance apparatus according to claim 8, wherein the target vehicle speed determination unit calculates, as the target vehicle speed region, a vehicle speed region required to pass through the traffic light location while the display condition of the traffic light corresponds to the passage permitting display condition.

13. The driving assistance apparatus according to claim 8, further comprising:
a target vehicle speed notification unit that notifies of the target vehicle speed region determined by the target vehicle speed determination unit.

14. A driving assistance apparatus that assists driving of a vehicle, comprising:
a vehicle speed sensor that detects a vehicle speed of the vehicle;
a communication unit that obtains light information relating to a change in a display condition of a traffic light disposed in an advancement direction of the vehicle;
a position calculation unit that calculates relative position information between the vehicle and a traffic light location where the traffic light is disposed; and
a target vehicle speed determination unit that determines whether or not the vehicle is permitted to pass through the traffic light location on the basis of the relative position information between the vehicle and the traffic light location, calculated by the position calculation unit, and the light information obtained by the communication unit, and that, after determining that the vehicle is permitted to pass through the traffic light location, determines, as a target vehicle speed region, a vehicle speed region required to pass through the traffic light location between a point following the elapse of a fourth threshold time after a change in a display condition of the traffic light from a passage non-permitting display condition indicating that vehicle passage is not permitted to a passage permitting display condition indicating that the vehicle passage is permitted and a point preceding, by a third threshold time, a change in the display condition of the traffic light from the passage permitting display condition to the passage non-permitting display condition.

15. The driving assistance apparatus according to claim 14, further comprising:
a target vehicle speed notification unit that notifies of the target vehicle speed region determined by the target vehicle speed determination unit.
